(19) United States
(12) Patent Application Publication
(10) Pub. No.: US 2013/0165121 A1
(43) Pub. Date: Jun. 27, 2013

(54) REDUCING DATA OPTIMIZED SESSION NEGOTIATION TIME AND FACILITATING ACTIVE HANDOFF

(71) Applicant: Qualcomm Incorporated, San Diego, CA (US)

(72) Inventors: Suli Zhao, San Diego, CA (US); Shian-De Ju, San Diego, CA (US); Prasanna V. Badrinarayanan, San Diego, CA (US)

(73) Assignee: QUALCOMM Incorporated, San Diego, CA (US)

(21) Appl. No.: 13/708,038

(22) Filed: Dec. 7, 2012

Related U.S. Application Data
(60) Provisional application No. 61/578,791, filed on Dec. 21, 2011.

(51) Int. Cl. H04W 36/00

(52) U.S. Cl. CPC H04W 36/0022
USPC 455/436

(57) ABSTRACT

A communication entity, such as a wireless communication device, is handed off from a one network to a data optimized network. To facilitate the handoff and interruptions that may occur during the handoff, the communication entity stores data optimized session state information. The communication entity notifies the data optimized network that it is ready to be handed off to the data optimized network after the communication entity determines it is ready to be handed off.

### CROSS-REFERENCE TO RELATED APPLICATIONS

This application is related to and claims priority from U.S. Provisional Patent Application Ser. No. 61/578,791 filed Dec. 21, 2011, for “REDUCE DO SESSION NEGOTIATION TIME AND FACILITATE LTE TO EHRPD ACTIVE HANDOFF,” which is incorporated herein by reference.

### TECHNICAL FIELD

The present disclosure relates generally to electronic communications. More specifically, the present disclosure relates to systems and methods for reducing data optimized (DO) session negotiation time and facilitating long term evolution (LTE) to evolved high rate packet data (eHRPD) active handoffs.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smartphones, computers, etc.) communicate with other electronic devices. For example, a wireless communication device (e.g., cellular phone, smartphone, etc.) may wirelessly communicate with a base station and vice-versa. This may enable the wireless communication device to access and/or communicate voice, video, data and so on.

Some electronic devices are capable of communicating using multiple technologies. These electronic devices may switch the technology used when another technology becomes available (such as from a different base station) or when circumstances warrant a switch (such as a need for a higher data transfer rate). These electronic devices may need to adjust communication settings that are used when such a switch occurs. Improvements in the switching capabilities of electronic devices may be beneficial.

### BRIEF DESCRIPTION OF THE DRAWINGS

FIG. 1 is a block diagram illustrating an active handoff of a wireless communication device from a source radio access network (RAN) to target RAN;

FIG. 2 is a block diagram illustrating one configuration of a wireless communication network;

FIG. 3 is a flow diagram of a method for decoupling session negotiation phases;

FIG. 4 is a call flow diagram illustrating the setup of a data optimized session negotiation between a wireless communication device, a source RAN and a target RAN via a tunnel;

FIG. 5 is a call flow diagram illustrating the setup of a data optimized session negotiation between a wireless communication device, an LTE RAN and an eHRPD RAN;

FIG. 6 is a flow diagram of a method for facilitating pre-registration on a wireless communication device;

FIG. 7 is a call flow diagram illustrating code division multiple access (CDMA) measurements, measuring reports, pre-registration parameters and active handoffs between a wireless communication device, an evolved node B (eNodeB) and an evolved access network (eAN);

FIG. 8 is a flow diagram of a method for facilitating active handoff using pre-registration status reporting;

FIG. 9 is a block diagram illustrating various types of connectivity between a wireless communication device and a core network that the wireless communication device may utilize for data services and/or voice services;

FIG. 10 is a block diagram illustrating the network architecture for evolved high rate packet data (eHRPD);

FIG. 11 shows part of a hardware implementation of an apparatus for executing the pre-registration methods described herein; and

FIG. 12 shows part of a hardware implementation of an apparatus for executing the phase state methods described herein.

### DETAILED DESCRIPTION

At least some aspects of the present disclosure relate to a communication entity, such as a wireless communication device, in which data optimized session negotiations may be facilitated. For example, the present disclosure may correspond to apparatuses, methods, circuitry, computer-product programs, etc. for negotiating a data optimized session.

A wireless communication device may communicate with multiple interfaces corresponding to different technologies, such as a long term evolution (LTE) interface, a wireless local area network (WLAN) interface, an evolved high rate packet data (eHRPD) interface, and so forth. The wireless communication device may be handed off from one technology interface, called a source technology interface, to another technology interface, called a target technology interface. Handing off the wireless communication device may require multiple steps or phases.

The present disclosure may facilitate more efficient handoffs by providing techniques for storing the wireless communication device's phase state during a multiphase handoff procedure. By storing the phase state of the wireless communication device, the wireless communication device may be handed off from the source technology interface to the target interface without unnecessarily repeating phases due to interruptions caused by the handoff, for example.

The present disclosure may also relate to a wireless communication device determining pre-registration status during handoff procedures. For example, the wireless communication device may determine that it is pre-registered based on one or more conditions being satisfied. According to the present disclosure, a wireless communication device may also send a pre-measurement report indicating if the wireless communication device is pre-registered and/or on what conditions the wireless communication device was pre-registered. For example, the wireless communication device may communicate its pre-registration status by sending a pre-registration parameter. As disclosed herein, the wireless communication device may send a pre-registration parameter along with a measurement report. In the case of multiple measurement reports being sent, the wireless communication device may send a pre-registration parameter that indicates that the wireless communication device is pre-registered along with the final measurement report sent.

In the following description, for reasons of conciseness and clarity, terminology associated with the LTE standards, as promulgated under the 3rd Generation Partnership Project (3GPP) by the international telecommunication union (ITU), is used. It should be noted that the invention is also applicable to other technologies, such as technologies and the associated standards related to code division multiple access (CDMA), time division multiple access (TDMA), frequency division multiple access (FDMA), orthogonal frequency division multiple access (OFDMA) and so forth. Terminologies associated with different technologies can vary. For example, depending on the technology considered, a wireless device can sometimes be called a user equipment (UE), a mobile station, a mobile terminal, a subscriber unit, an access terminal, etc., to name just a few. Likewise, a base station can sometimes be called an access point, a Node B, an evolved Node B (eNB or eNodeB), and so forth. It should be noted that different terminologies apply to different technologies when applicable.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

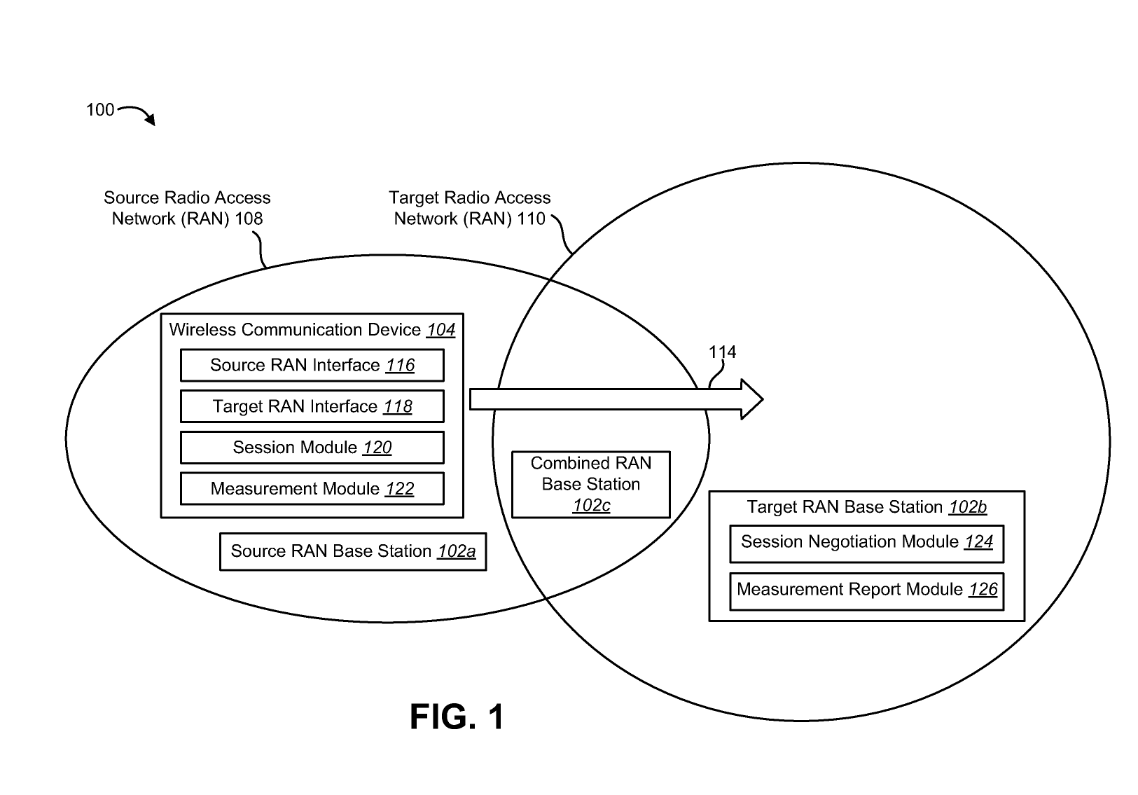

FIG. 1 is a block diagram illustrating an active handoff of a wireless communication device 104 from a source radio access network (RAN) 108 to target RAN 110. The source RAN 108 and the target RAN 110 may each employ a different radio access technology (RAT) requiring the wireless communication device 104 to be able to interface with each RAN individually. The source RAN 108 may have a smaller footprint than the target RAN 110. For example, in some configurations, the footprint of the source RAN 108 may be fully encompassed in the footprint of the target RAN 110. In some configurations, the footprint of the source RAN 108 may partially overlap the footprint of the target RAN 110. Both the source RAN 108 and the target RAN 110 may be part of the same wireless communication system 100.

A wireless communication system 100 may provide communication services for many different types of electronic devices. Such devices include, but are not limited to, cellular telephones, wireless modems, computers, digital music players, global positioning system units, personal digital assistants, gaming devices, etc. As used herein, the term “wireless communication device” 104 refers to an electronic device that may be used for voice and/or data communication over a wireless communication system 100. Examples of wireless communication devices 104 include cellular phones, handheld wireless devices, wireless modems, laptop computers, personal computers, etc. A wireless communication device 104 may alternatively be referred to as an access terminal, a mobile terminal, a subscriber station, a remote station, a user terminal, a terminal, a subscriber unit, user equipment (UE), etc. In general, a wireless communication device 104 that is capable of connecting to an enhanced packet core (EPC) network (i.e., a core network that supports the evolved high rate packet data (eHRPD) and long term evolution (LTE) technologies) may be referred to as either a wireless communication device 104 or an enhanced access terminal (eAT). A wireless communication device 104 may also be capable of connecting to legacy 1x/HRPD networks.

With respect to EPC technologies, a wireless communication device 104 may be one of three types: an eHRPD only device, an LTE only device or an eHRPD and LTE device. The wireless communication device 104 may have the ability to obtain services from an access point via different RATs, such as the source RAN 108 and the target RAN 110. The wireless communication device 104 may obtain services from multiple access points.

The wireless communication system 100 may provide communication for a number of wireless communication devices, each of which may be serviced by one or more base stations 102. The one or more base stations 102 may also be referred to as an access point (AP), a Node B or some other terminology. The one or more base stations 102 may be part of a 1x evolution-data optimized (EV-DO) RAN. A 1x EV-DO RAN is a part of a mobile telecommunication system that implements a RAT. A 1x EV-DO RAN may include multiple base stations 102 (e.g., target RAN base station 102b and combined RAN base station 102c). Each base station 102 may provide access to the same or different core networks.

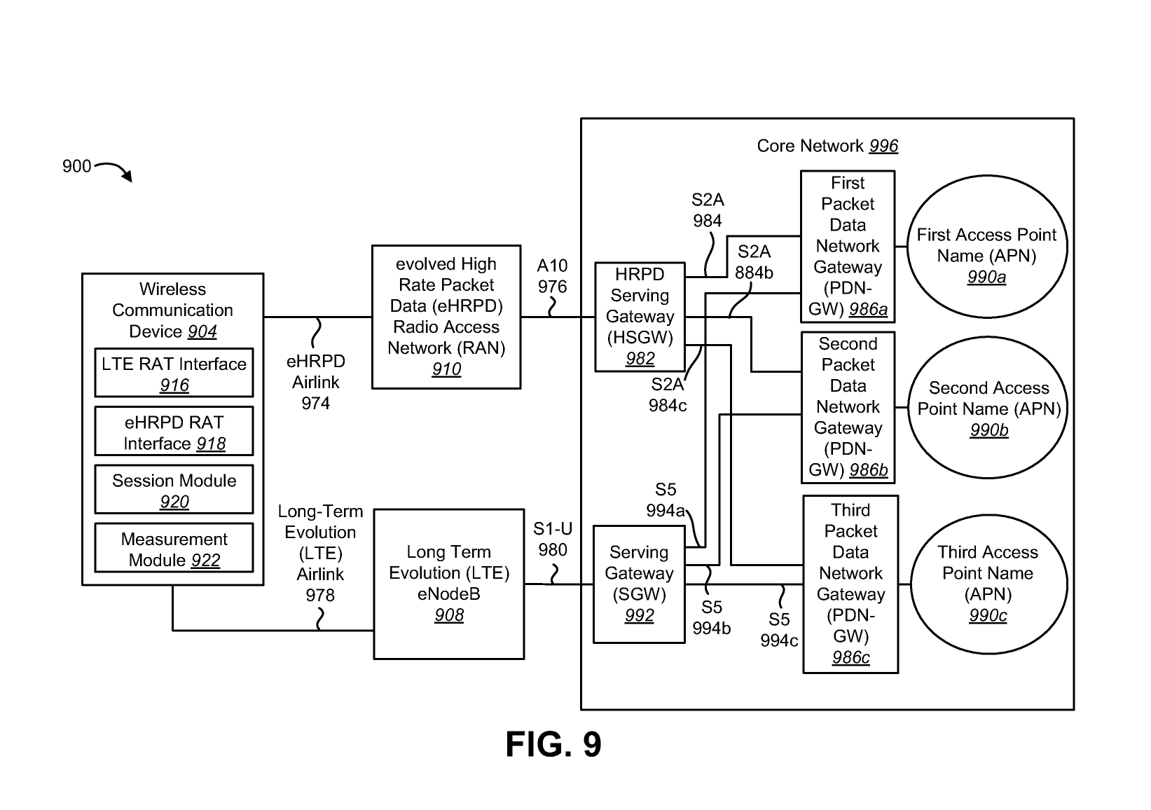

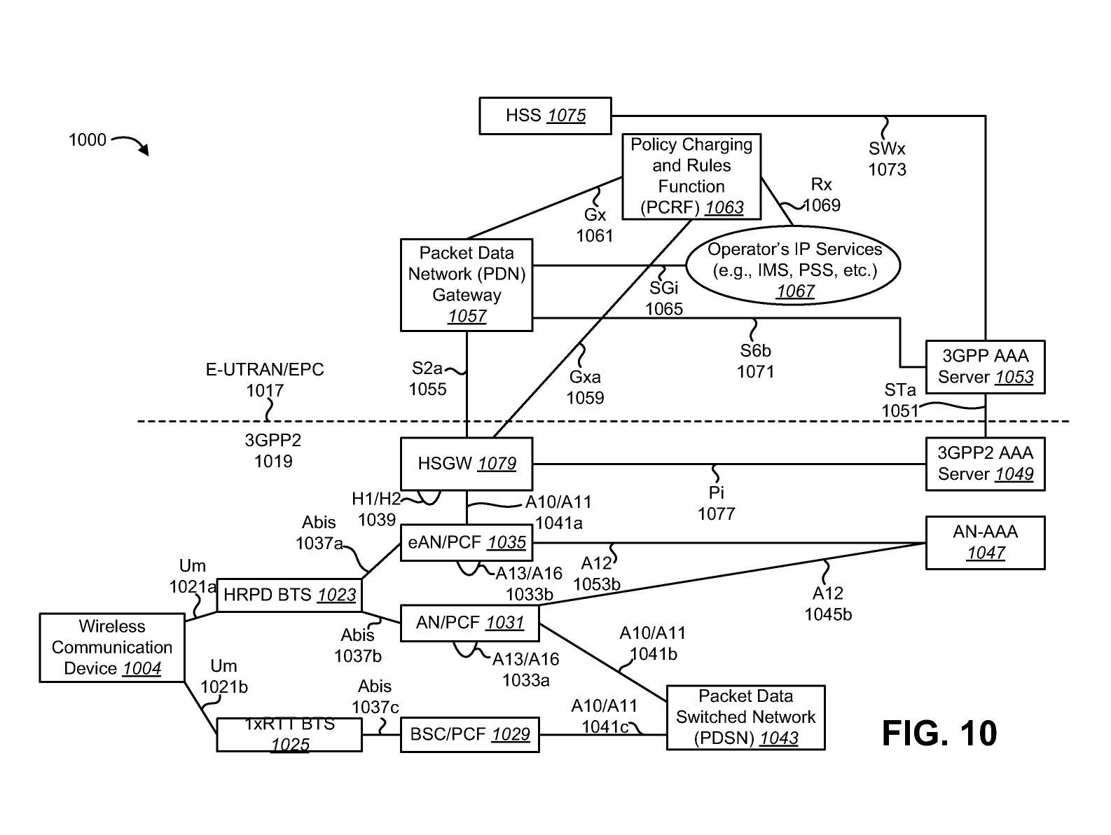

A wireless communication device 104 may obtain service via multiple network access systems. For example, the wireless communication device 104 may obtain access to core networks (not shown) via high rate packet data (HRPD) systems, eHRPD systems and data optimized (DO) systems such as a 1x EV-DO system. HRPD systems are further described below in FIG. 9 and FIG. 10.

The wireless communication device 104 may include a source RAN interface 116 and a target RAN interface 118. The source RAN interface 116 may allow the wireless communication device 104 to communicate with a source RAN base station 102a located on the source RAN 108. The target RAN interface 118 may allow the wireless communication device 104 to communicate with a target RAN base station 102b located on the target RAN 110.

The wireless communication device 104 may move from the source RAN 108 to the target RAN 110. However, in moving from the source RAN 108 to the target RAN 110, a handover or handoff 114 may be required. In transitioning from the source RAN 108 to the target RAN 110, the wireless communication device 104 may need to be reconfigured to the target RAN 110. For example, the wireless communication device 104 may need to negotiate a communication link with a target RAN 110 before being able to utilize data and voice services on the target RAN 110. One approach to establish a communication link between the wireless communication device 104 and the target RAN 110 may be via a session negotiation.

The wireless communication device 104 may include a session module 120 and a measurement module 122. A corresponding session negotiation module 124 and measurement report module 126 may be included on the target RAN base station 102b. The session module 120 on the wireless communication device 104 may communicate with session negotiation module 124 on the target RAN base station 102b to negotiate a session. For example, the session may be a data optimized (DO) session.

The measurement module 122 on the wireless communication device 104 may communicate with the measurement report module 126 on the target RAN base station 102b to measure communication conditions and to facilitate a handoff 114 from the source RAN 108 to the target RAN 110.

The transition from the source RAN 108 to the target RAN 110 may cause communication interruptions to the wireless communication device 104. These communication interruptions may result in additional unnecessary steps needing to be performed by the wireless communication device 104.

In some configurations, the wireless communication device 104 may move from a combined RAN base station 102c to the target RAN base station 102b. The combined RAN base station 102c may be able to communicate with the wireless communication device 104 using both the source RAT and the target RAT. However, the wireless communication device 104 may face similar challenges as described above when transitioning from the source RAT to the target RAT. For example, interruptions caused when handing off a wireless communication device 104 may result in wasted time and radio signaling as well as steps being unnecessarily repeated.

The source RAN 108 may be an LTE network and the target RAN 110 may be an evolved high rate packet data (eHRPD) network. In this configuration, the wireless communication device 104 may be communicating with the source RAN 108 using LTE. The wireless communication device 104 may then move to an area (e.g., the target RAN 110) that is supported by eHRPD. The wireless communication device 104 may be handed off 114 from the LTE to the eHRPD network. The process of handing off the wireless communication device 104 from a source RAN 108 to a target RAN 110 may be referred to as an active handoff 114.

When the wireless communication device 104 moves from LTE to eHRPD, the wireless communication device 104 may need to complete DO session negotiation before it can establish data session and/or start transferring data over eHRPD. In other words, in the context of eHRPD, DO session negotiation may be required for a wireless communication device 104 to be actively handed off to an eHRPD network. Only after a wireless communication device 104 is actively handed off may it begin to utilize data services over eHRPD. DO session negotiation currently requires a large portion of time to complete, for example 3-6 seconds.

The DO session negotiation may be a multistep or multiphase process. DO session negotiations that include multiple phases may have the phases coupled to each other. If the phases may be closely tied to each other, the failure of one phase results in the failure of all phases. However, if the phases are decoupled, a failure in one phase will not result in failure to all phases.

In known configurations, if a failure happens during one of the phases of a DO session negotiation process, the process is required to restart from the beginning. Thus, because the phases are closely tied together, any type of failure requires a restart of the entire DO session negotiation. In a multiphase DO session negotiation, a failure in any of the phases may occur. For example, a failure may occur if a connection is closed in one phase or if a configuration session times out in another phase. Thus, if one of the phases is interrupted, the DO negotiation session must be reattempted from before the first phase, even if the first phase was successfully completed. This process is repeated until the DO session process is completed successfully.

There may be three phases in an EV-DO session negotiation process. In phase 1, the wireless communication device 104 may begin the DO session negotiation by requesting an identifier. The identifier may be a unicast access terminal identifier (UATI). The identifier may allow the target RAN 110 to uniquely identify a wireless communication device 104 within a subnet of the network, such as a 1xEV-DO network. The identifier may be used by the target RAN 110 to send directed signaling messages to the wireless communication device 104. Similarly, the wireless communication device 104 may include the identifier whenever the wireless communication device 104 sends an access request to the target RAN 110 so the wireless communication system 100 may know where the access request is coming from.

Phase 1, or the first phase, may be referred to as a session setup. Phase 1 may be performed over an open control channel. The control channel is not a dedicated channel.

In phase 2, the wireless communication device 104 and the target RAN 110 may set up a connection. Phase 2 may occur on a dedicated traffic channel. Phase 2 may be referred to as opening a connection.

The traffic channel may be assigned to the wireless communication device 104 by the target RAN 110. In some configurations, traffic control access may occur via S101. The active handoff 114 with traffic control access may occur via S101. For example, the target RAN 110 may assign the traffic channel to the wireless communication device 104 via the S101 tunnel connection. This may allow the wireless communication device 104 to directly connect to the target RAN 110 during the handover. In this manner, the handoff may only take about 100 milliseconds (ms) to acquire the target RAN's 110 traffic channel and real-time services may be better facilitated during the handoff.

An S101 connection is a signaling interface connection that allows the wireless communication device 104 to tunnel HRPD air interface signaling over an LTE system. For example, if the source RAN 108 is an LTE network, the wireless communication device 104 may be connected to the source RAN 108 (e.g., eHRPD) through the S101 connection.

In phase 3, the wireless communication device 104 and the target RAN 110 may negotiate one or more sets of protocol and/or application subtypes along with relevant parameters. Phase 3 may be referred to as a session configuration. Phase 3 may be followed by a connection close.

As described above, in known approaches, the three phases are closely tied together. If a failure or interruption occurs before phase 3 is complete, the session negotiation between the wireless communication device 104 and the base station 102 may need to restart from the beginning of phase 1. For example, when an active handoff 114 request is received by the wireless communication device 104, the wireless communication device 104 may complete phase 1 of the session negotiation over S101. However, upon handing off from the source RAN 108 to the target RAN 110, the wireless communication device 104 may have to restart from the beginning of phase 1 because the handoff 114 interrupted the wireless communication device 104 moved from the source RAN 108 to the target RAN 110.

As another example, in other handoff scenarios with S101, such as a redirection request, the wireless communication device 104 may finish phase 1 over S101 before being redirected and handed off. Again, the wireless communication device 104 may have to restart from the beginning of phase 1 after the handoff 114. Similarly, for handoff scenarios where the wireless communication device 104 is not employing S101, such as while transitioning from EV-DO to LTE, the wireless communication device 104 may complete phase 1 before being handed off. Again, the wireless communication device 104 may be required to restart from the beginning of phase 1 after the handoff 114. One reason for the wireless communication device 104 being required to restart the session negotiation process is because the wireless communication device 104 may be unable to retain the identifier and thus, the state of completed phase 1. Therefore, the wireless communication device 104 must restart phase 1 of the session negotiation to reacquire the identifier, even if the identifier was successfully assigned to the wireless communication device 104 before the active handoff 114.

When the wireless communication device 104 has to restart from the beginning of phase 1, unnecessary radio signaling and increases in service interruption may occur. Because phase 1 may take around 1 second to complete, each restart increase the overall session negotiation time. The systems and methods described herein may be beneficial for reducing the DO session negotiation time during an active handoff 114. For instance, the DO session negotiation time during a handoff 114 from LTE to eHRPD may be reduced.

In some configurations, the active handoff 114 may be performed over an S101 connection. If the source RAN 108 is an LTE network, the wireless communication device 104 may be connected to the source RAN 108 (e.g., eHRPD) through the S101 connection. The S101 connection allows the wireless communication device 104 to acquire DO traffic channel directly during an active handoff 114 to eHRPD. Thus, when the wireless communication device 104 is actively handed off from the source RAN 108 (e.g., the LTE network) to the target RAN 110 (e.g., the eHRPD network), the wireless communication device 104 may employ the S101 tunnel connection actively to begin the DO session negotiation with the eHRPD network.

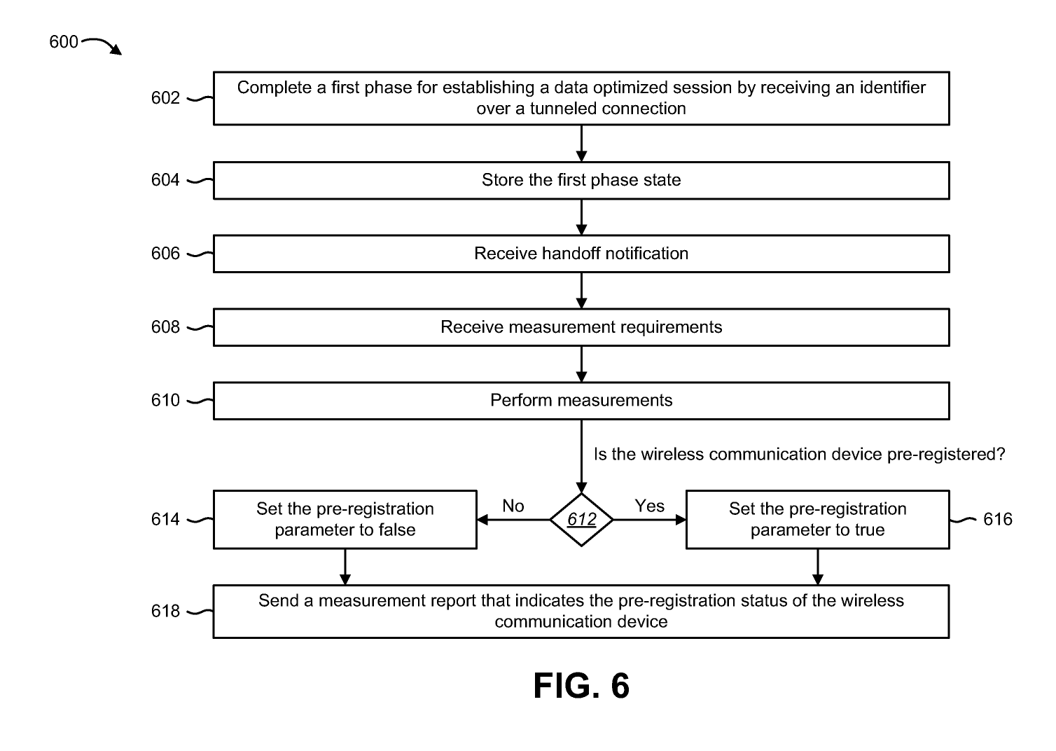

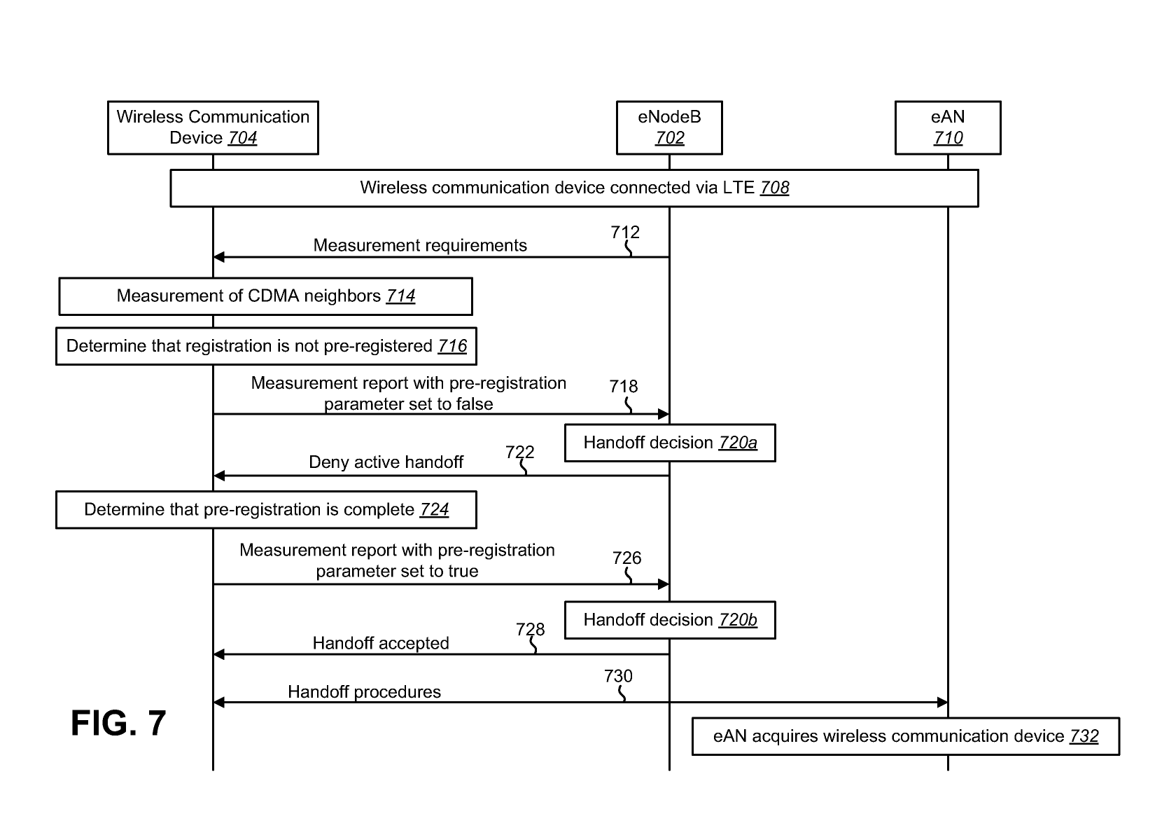

In other configurations, whether or not the wireless communication device 104 is ready to be actively handed off may be based on the wireless communication device's 104 eHRPD pre-registration status. A wireless communication device's 104 pre-registration status may indicate if the wireless communication device 104 is configured to be handed off to eHRPD. However, under current approaches, protocol is lacking as to when a wireless communication device 104 may consider itself pre-registered. Accordingly, the systems and methods may also describe conditions under which a wireless communication device 104 may manage the wireless communication device's 104 eHRPD pre-registration status to facilitate active handoff 114 to an eHRPD network. Pre-registration of a wireless communication device 104 will be further described below in FIG. 6 and FIG. 7.

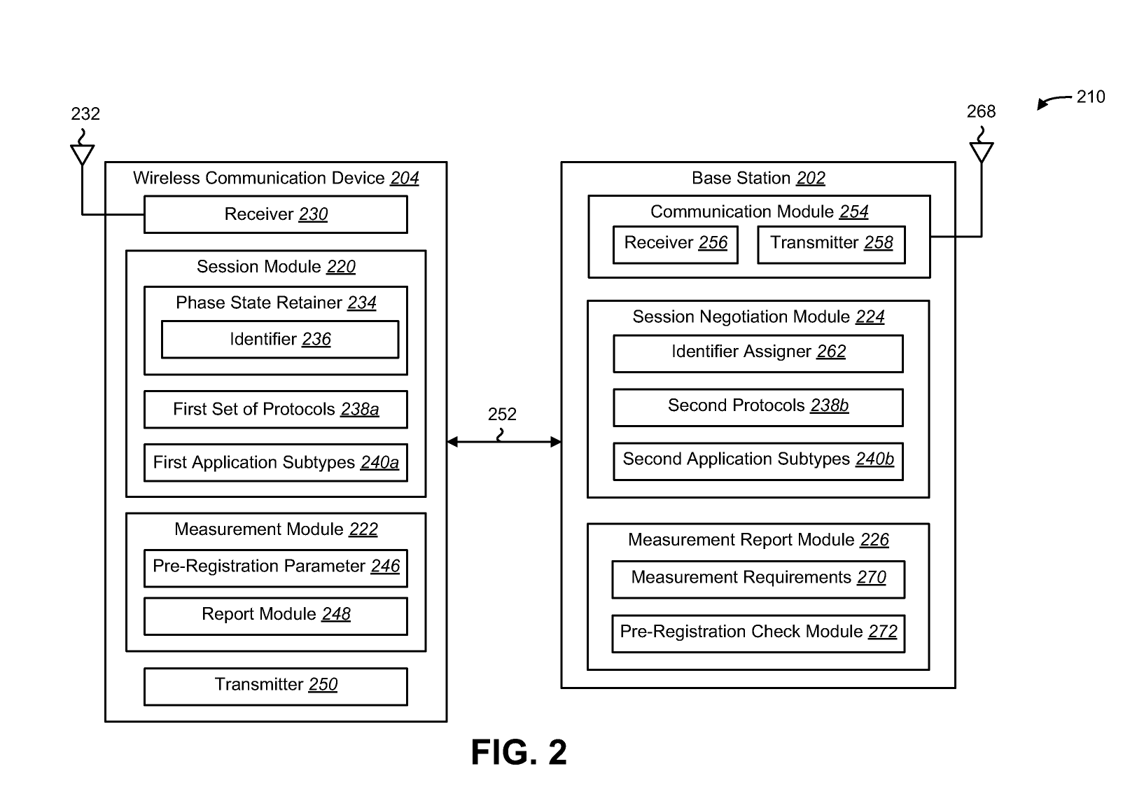

FIG. 2 is a block diagram illustrating one configuration of a wireless communication network 210. The wireless communication device 204 may be one configuration of the wireless communication device 104 described in connection with FIG. 1. As described in FIG. 2, the base station 202 may be one configuration of the target RAN base station 102b described in connection with FIG. 1. However, it should be appreciated that the base station 202 may be one configuration of the source RAN base station 102a or the combined RAN base station 102c of FIG. 1.

Further, the wireless communication network 210 of FIG. 2 may be one configuration of the target RAN 110 described in connection with FIG. 1. In other words, as illustrated in FIG. 2, the wireless communication device 204 may be actively handed off to the target RAN 110 (e.g., wireless communication network 210), which includes the base station 202.

The wireless communication device 204 may include a receiver 230, a transmitter 250 and an antenna 232 for receiving information 252 from and/or for transmitting information 252 to the base stations 202. It should be noted that only one antenna 232 is illustrated on the wireless communication device 204 for simplicity, however multiple antenna may be employed by the wireless communication device 204.

The wireless communication device 204 may include a session module 220 and a measurement module 222. The session module 220 may facilitate session negotiations with the wireless communication network 210. For example, the session module 220 may communicate with a session negotiation module 224 located on the base station 202.

The session module 220 may include a phase state retainer 234, a first set of protocols 238a and a first application subtypes 240a. The phase state retainer 234 may retain the state of completed negotiated session phases. The phase state retainer 234 may include an identifier 236, which may allow the phase state retainer 234 to retain the state of a completed negotiated session phase.

If the wireless communication device 204 is actively handing off from a source RAN 108, such as an LTE network, to a target RAN 110, such as an eHRPD network, the wireless communication device 204 may need to establish a communication link with the target RAN 110. One approach to establish this communication link may be through a session negotiation, such as a DO session negotiation.

In an eHRPD network, a DO session negotiation may involve multiple phases or steps. Phase 1 may include a session setup where wireless communication device 204 requests an identifier 236 and the wireless communication network 210 assigns the wireless communication device 204 an identifier 236. The wireless communication network 210 may assign the identifier 236 to the wireless communication device 204 via the identifier assigner 262 on the base station 202. For example, the identifier assigner 262 may assign a UATI to the wireless communication device 204.

The wireless communication device 204 may store the identifier 236 in the phase state retainer 234. When phase 2 is interrupted during an active handoff, rather than restarting phase 1 and re-requesting the identifier from the wireless communication network 210, the wireless communication device 204 may retrieve the identifier 236 from the phase state retainer 234. In this manner, the state of phase 1 may be stored and the wireless communication device 204 will not have to repeat phase 1 when a failure or interruption occurs in either phase 2 or phase 3. Thus, unnecessary radio signaling and service interruptions may be avoided.

Phase 2 may include opening a connection between the wireless communication device 204 and the wireless communication network 210. For example, the connection may be a dedicated traffic channel to transmit and/or receive information 252. Phase 3 may include the session configuration. The session module 220 on the wireless communication device 204 and the wireless communication network 210 (via the session negotiation module 224 on the base station 202) may negotiate one or more sets of protocol 238 and/or application subtypes 240 along with relevant parameters.

The measurement module 222 on the wireless communication device 204 may include a pre-registration parameter 246 and a report module 248. The measurement module 222 may receive measurement requirements 270 from the measurement report module 226 on the base station 202. The measurement requirements 270 may instruct the wireless communication device 204 to measure signal conditions and report results to the base station 202. For example, the measurement requirements 270 may instruct the wireless communication device 204 to measure CDMA signal levels in neighboring cells. The wireless communication device 204 may employ a report module 248 to compose the measurement report to the base station 202.

The measurement report may be accompanied by the pre-registration parameter 246. For example, the pre-registration parameter 246 may be included in the measurement report or may be separate from the measurement report, such as in the same transmission. The pre-registration parameter 246 may be an eHRPD parameter or a parameter flag such as preRegistrationStatusHRPD and may be set to true if the wireless communication device is pre-registered for communication on the eHRPD network. Pre-registration of a wireless communication device 104 will be further described below in FIG. 6 and FIG. 7.

The base station 202 may include a communication module 254 that includes a receiver 256, a transmitter 258. The communication module 254 may be coupled to an antenna 268 for receiving information 252 from and/or for transmitting information 252 to the wireless communication device 204. It should be noted that only one antenna 268 is illustrated on the base station 202 for simplicity, however multiple antenna may be employed by the wireless communication device 204.

The base station 202 may receive the measurement report and the pre-registration parameter 246. A pre-registration check module 272 may check if the wireless communication device 204 is pre-registered for communication on an eHRPD network, for example. Based on the pre-registration parameter 246, the measurement report module 226 may determine whether the wireless communication device 204 may continue with the active handoff to eHRPD based on measurement results and the pre-registration parameter 246. For example, the measurement report module 226 may determine that the wireless communication device 204 may continue with the active handoff to eHRPD based on CDMA measurement results and the preRegistrationStatusHRPD.

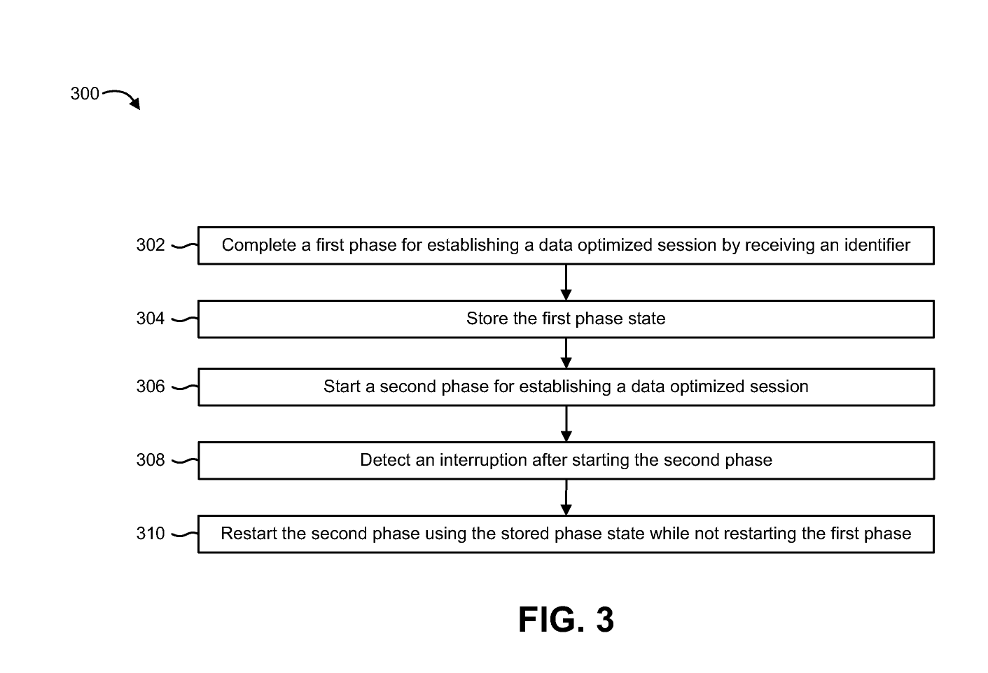

FIG. 3 is a flow diagram of a method 300 for decoupling session negotiation phases. The method 300 may be performed by a wireless communication device 104. The wireless communication device 104 may complete 302 the first phase for establishing a data optimized (DO) session. Phase 1 may be completed by receiving an identifier 236. For example, the wireless communication device 104 may request and may receive a UATI as the identifier 236. The wireless communication device 104 may request the identifier 236 in response to beginning a DO session negotiation with a target RAN 110.

The wireless communication device 104 may store 304 the first phase state. The wireless communication device 104 may store the first phase state, for example, by storing the identifier 236 in a phase state retainer 234. In this manner, the wireless communication device 104 may retain the state of phase 1 after phase 1 has been successfully completed.

The wireless communication device 104 may start 306 a second phase for establishing a DO session. The wireless communication device 104 may detect 308 an interruption after starting the second phase. For example, during phase 2, the wireless communication device 104 may be handed off from a source RAN 108 to a target RAN 110, which may interrupt or cause phase 2 to fail. For instance, the wireless communication device 104 may be handed off from LTE to eHRPD, which may interrupt phase 2.

If phase 2 fails or is interrupted, the wireless communication device 104 may retain the state of phase 1. Thus, after a handoff to the target RAN 110, the wireless communication device 104 may restart 310 the second phase using the stored first phase state while not restarting the first phase. In other words, by employing the stored phase state, the wireless communication device 104 may restart from phase 2 instead of from phase 1 after a phase 2, or even a phase 3 interruption. In this manner, the phases of the DO session negotiation are decoupled. An interruption in phase 2 and/or phase 3 will not result in the entire process restarting. One benefit of decoupling the session negotiation phases is that radio signaling for a DO session negotiation and service interruption time during a handoff 114 are reduced.

In this manner, the wireless communication device 104 may retain the state of phase 1 even during an active handoff. The wireless communication device 104 may retain the state of completed phase 1 when using an S101 connection with the source RAN 108 (e.g., LTE) during an active handoff. For example, if the wireless communication device 104 moves from LTE to DO (e.g., eHRPD) while connected with S101, the wireless communication device 104 may retain the state of phase 1. After moving to DO, the wireless communication device 104 may continue from phase 2, even if the handoff resulted in an interruption.

Similarly, the wireless communication device 104 may retain the state of completed phase 1 when not using an S101 connection. For example, if the wireless communication device 104 moves from DO to LTE and then later moves back to DO without S101, the wireless communication device 104 may retain the state of phase 1 and continue from phase 2 after the handoff, even if the handoff results in an interruption.

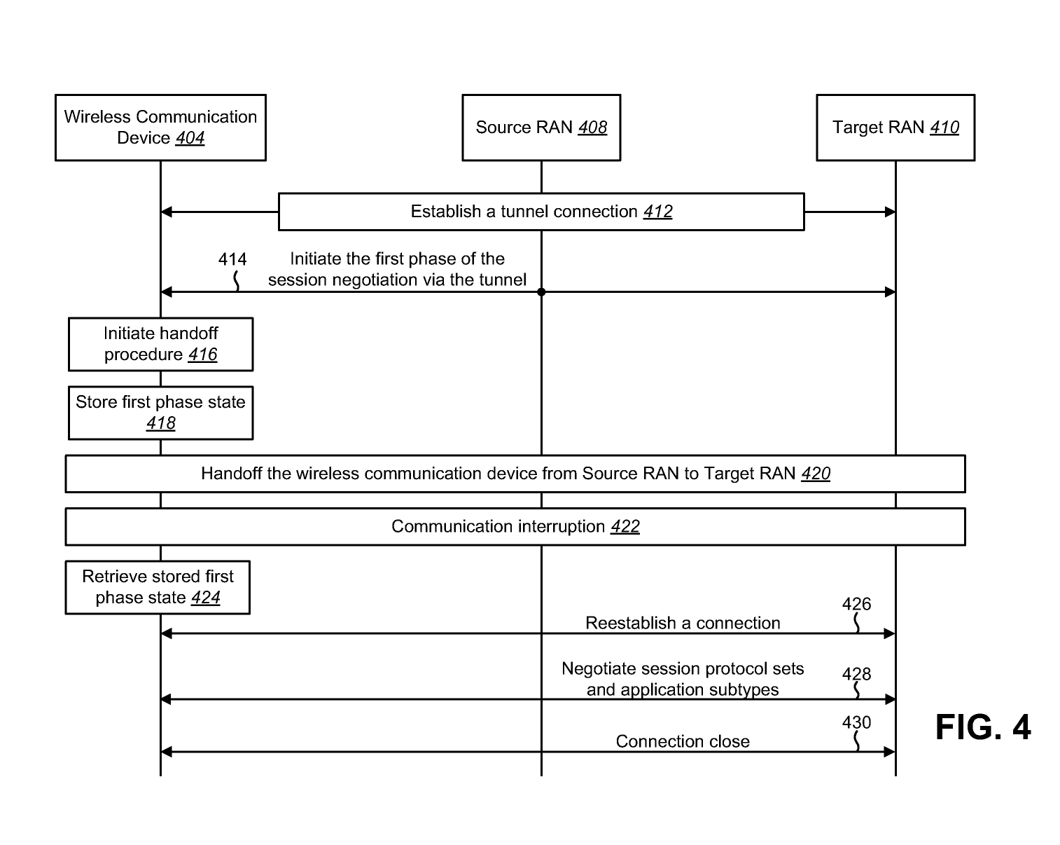

FIG. 4 is a call flow diagram illustrating the setup of a data optimized session negotiation between a wireless communication device 404, a source RAN 408 and a target RAN 410 via a tunnel. The wireless communication device 404 may be one configuration of the wireless communication device 104 described in connection with FIG. 1. The source RAN 408 and the target RAN 410 of FIG. 4 may be one configuration of the source RAN 108 and the target RAN 110 described in connection with FIG. 1, respectively.

The source RAN 408 may establish 412 a tunnel connection between the wireless communication device 404 and the target RAN 410. For example, the connection may be via S101. In this example, the source RAN 408 may be an LTE network and the target RAN 410 may be an eHRPD network. The target RAN 410 may require DO session negotiation to be completed before the wireless communication device 404 may utilize data services on the eHRPD network (e.g., the target RAN 410.)

The wireless communication device 404 may initiate 414 the first phase of the session negation with the target RAN 410. The wireless communication device 404 may perform the first phase of the session negotiation using the tunnel established by the source RAN 408.

The first phase may include requesting an identifier 236, such as a UATI. The identifier 236 may be assigned to the wireless communication device 404 by the target RAN 410.

The wireless communication device 404 may initiate 416 handoff procedures. For example, the wireless communication device 404 may determine that a handoff from the source RAN 408 to the target RAN is necessary. In some configurations, the handoff may be triggered by the source RAN 408.

The wireless communication device 404 may complete the first phase with the target RAN 410 and may store 418 the state of the first phase. The wireless communication device 404 may store the state of the first phase in the phase state retainer 234. For instance, the wireless communication device 404 may store the identifier 236 in the phase state retainer 234, which may indicate the stored state of the first phase.

The source RAN 408 may handoff 420 the wireless communication device 404 to the target RAN 410. During the handoff, the communication of the wireless communication device 404 may be interrupted 422. For example, communications may be interrupted when the wireless communication device 404 is handed off from the source RAN 408 to the target RAN 410.

After the communication interruption 422, the wireless communication device 404 may retrieve 424 the stored first phase state. In this manner, the wireless communication device 404 may prevent having to repeat the first phase (e.g., phase 1) of the DO session negotiation.

The wireless communication device 404 may reestablish 426 a connection with the target RAN 410. The connection may be a direct connection via the traffic channel. In other words, the wireless communication device 404 is no longer connected to the source RAN 408. After a direct connection with the target RAN 410 is established, phase 2 may be completed.

The wireless communication device 404 may complete phase 3 by negotiating 428 session protocols sets 238 and application subtypes 240 with the target RAN 410. The wireless communication device 404 and target RAN 410 may then close 430 the DO connection. In this manner, the wireless communication device 404 may facilitate a more efficient active hand off and avoid delays in the DO session negotiation process.

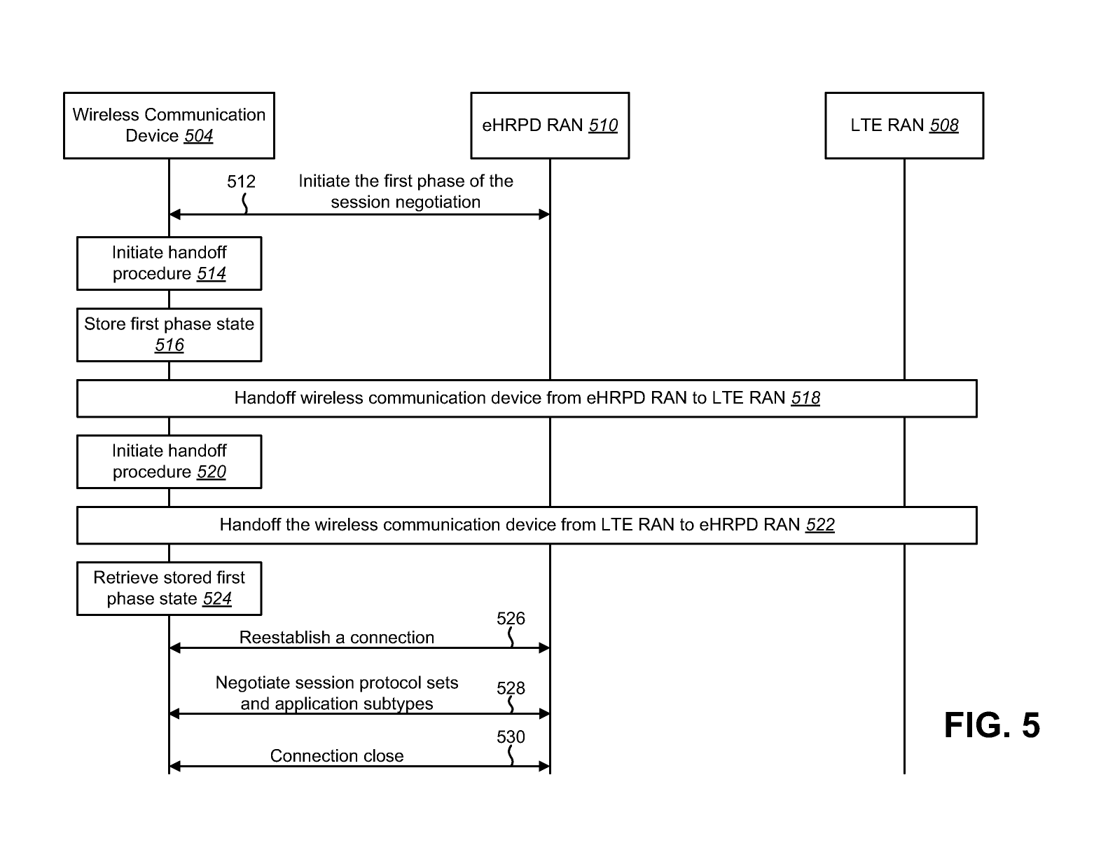

FIG. 5 is a call flow diagram illustrating the setup of a data optimized session negotiation between a wireless communication device 504 and an eHRPD RAN 508. The wireless communication device 504 may be one configuration of the wireless communication device 104 described in connection with FIG. 1. The LTE RAN 508 and the eHRPD RAN 510 of FIG. 5 may be one configuration of the source RAN 108 and the target RAN 110 described in connection with FIG. 1, respectively.

The wireless communication device 504 may be connected to the eHRPD RAN 510. The eHRPD RAN 510 may require DO session negotiation to be completed before the wireless communication device 504 may utilize data services on the eHRPD RAN 510. The wireless communication device 504 may initiate 512 the first phase of the session negation with the eHRPD RAN 510. Completing the first phase may include requesting an identifier 236, such as a UATI. In this manner, the wireless communication device 504 may perform the first phase of the session negotiation without using a tunnel connection, such as S101.

The eHRPD RAN 510 may initiate 514 handoff procedures. In some configurations, the wireless communication device 504 may determine that a handoff is necessary. In this example, the wireless communication device 504 may initiate the handoff procedures.

The wireless communication device 504 may complete the first phase with the eHRPD RAN 510 and may store 516 the state of the first phase. The wireless communication device 504 may store the state of the first phase in the phase state retainer 234. For instance, the wireless communication device 504 may store the identifier 236 in the phase state retainer 234, which may indicate the stored state of the first phase.

The wireless communication device 504 transitions from the eHRPD RAN 510 to the LTE RAN 508. In other words, the wireless communication device 504 may be handed off 518 to the LTE RAN 508. After a period of time, handoff procedures may again be initiated 520 and the wireless communication device 504 may be handed off 522 from the LTE RAN 508 back to the eHRPD RAN 510.

Rather than repeating phase 1 of the session negotiation with the eHRPD RAN 510, the wireless communication device 504 may retrieve 524 the stored first phase state. The wireless communication device 504 may reestablish 526 a connection with the eHRPD RAN 510. The connection may be a direct connection via the traffic channel. After a connection with the eHRPD RAN 510 is established, phase 2 may be completed.

The wireless communication device 504 may complete phase 3 by negotiating 528 session protocols sets 238 and application subtypes 240 with the eHRPD RAN 510. The wireless communication device 504 and eHRPD RAN 510 may then close 530 the DO connection. In this manner, the wireless communication device 504 may facilitate a more efficient active hand off and avoid delays in the DO session negotiation process when switching back and forth from an eHRPD RAN 510 and a LTE RAN 508.

FIG. 6 is a flow diagram of a method 600 for facilitating pre-registration on a wireless communication device 104. The method 600 may be performed by a wireless communication device 104. The wireless communication device 104 may complete 602 a first phase for establishing a data optimized session by receiving an identifier over a tunneled connection. For example, a source RAN base station 102a may establish an S101 tunnel connection with the target RAN 110. The wireless communication device 104 may receive an identifier 236, such as a UATI, over the S101 connection.

The wireless communication device 104 may store 604 the first phase state. This may be accomplished as described above in connection with FIG. 2 above.

The wireless communication device 104 may receive 606 a handoff notification. For example, the wireless communication device 104 may be notified that it is being handed off using an S101 connection from the source RAN 108 to the target RAN 110. In this manner, the wireless communication device 104 may continue with phase 3 even if phase 2 fails over the S101 because of the active handoff.

When the wireless communication device 104 is being actively handed off, the target RAN base station 102b may send measurement requirements to the wireless communication device 104. The wireless communication device 404 may receive 608 measurement requirements 270. The measurement requirements 270 may be received, for example, from a base station 102. The measurement requirements 270 may instruct the wireless communication device 104 to measure signal conditions and report results to the base station 102. For example, the measurement requirements 270 may instruct the wireless communication device 104 to measure CDMA signal levels in neighboring cells.

The wireless communication device 104 may perform 610 measurements. The measurements may be included in a measurement report. For example, the report module 248 in the measurement module 222 may compile the measurement report. The wireless communication device 104 may also send a pre-registration status along with the measurement report.

The wireless communication device 104 may determine 612 whether the wireless communication device 104 is pre-registered. The wireless communication device 104 may have one or more parameters in addition to the pre-registration parameter 246 that indicate with what approach the wireless communication device 104 considered itself to be pre-registered. For example, the wireless communication device 104 may include a parameter that indicates that the wireless communication device 104 was pre-registered when an evolved high rate packet data session was created. In some configurations, the pre-registration parameter 246 may include the approach for which the wireless communication device 104 considered itself to be pre-registered. The active handoff may proceed once the wireless communication device 104 is pre-registered. For example, phase 2 and/or phase 3 may be completed after the active handoff.

The wireless communication device 104 may consider itself to be pre-registered if one of the following conditions is satisfied. In one configuration, the wireless communication device 104 may consider itself to be pre-registered if an identifying assignment, such as a UATI assignment, is complete. In other words, one condition for the wireless communication device 104 considering itself to be pre-registered is that phase 1 is complete.

In another configuration, the wireless communication device 104 may consider itself to be pre-registered if an eHRPD session is created. For an eHRPD session to be created, the identifier 236, such as UATI, should have been assigned to the wireless communication device 104.

In yet another configuration, the wireless communication device 104 may consider itself to be pre-registered if an eHRPD session is created and a point-to-point (PPP) context is created. In this configuration, both an eHRPD session and a PPP context must be created before the wireless communication device 104 considers itself pre-registered.

In still yet another configuration, the wireless communication device 104 may consider itself to be pre-registered if an eHRPD session is created and a PPP, internet protocol (IP) and quality of service (QoS) context are created. Additionally, the wireless communication device 104 may consider itself to be pre-registered based on instructions sent from the base station 102.

The selected condition may be indicated by the wireless communication system 100. Additionally or alternatively, the selected condition may be configured on the wireless communication device 104. Thus, depending on if the selected condition is satisfied, the wireless communication device 104 may consider itself to be pre-registered.

If the wireless communication device 104 determines 612 that the wireless communication device 104 is pre-registered, the wireless communication device 104 may set 616 the pre-registration parameter 246 to true. For example, the wireless communication device 104 may set 616 the pre-registration parameter 246 preRegistrationStatusHRPD to true.

The wireless communication device 104 may then send 618 a measurement report that indicates the pre-registration status of the wireless communication device 104. For example, the wireless communication device 104 may send 618 the measurement report to the measurement report module 226 on the base station 102. The measurement report may include the pre-registration parameter 246 set to true.

Once the target RAN 110 confirms that the wireless communication device 104 is pre-registered, the active handoff process may proceed. The wireless communication device 104 may continue with session configurations (e.g., phase 3) once the wireless communication device 104 is handed off to eHRPD.

If the wireless communication device 104 determines 612 that the wireless communication device 104 is not pre-registered, the wireless communication device 104 may set 614 the pre-registration parameter 246 to false. In the case that the pre-registration parameter 246 is already set to false, the wireless communication device 104 may leave the pre-registration parameter 246 as false. The wireless communication device 104 may then send 618 a measurement report that indicates the pre-registration status of the wireless communication device 104. For example, the wireless communication device 104 may send a measurement report that includes the pre-registration parameter 246 set to false.

In addition to telling the base station 102 whether the wireless communication device 104 is pre-registered or not, the wireless communication device 104 may also signal a parameter to the base station 102 that indicates what procedures of eHRPD pre-registration that the wireless communication device 104 has completed (e.g., an identifier assignment is complete, the eHRPD session is created, the eHRPD session and the PPP context are created or an eHRPD session and the PPP, IP and QoS context are created).

FIG. 7 is a call flow diagram illustrating code division multiple access (CDMA) measurements, measuring reports, pre-registration parameters and active handoffs between a wireless communication device 704, an eNodeB 702 and an eAN 710. The wireless communication device 704, the eNodeB 702 and the eAN 710 of FIG. 7 may be one configuration of the wireless communication device 104, the target RAN base station 102b and the target RAN 410 of FIG. 1. In some configurations, the eAN 710 may be a joint eAN/evolved packet control function (ePCF).

The wireless communication device 704 may be connected 708 to the eAN 710 via an LTE network, for example, by S101 via a tunnel connection. The LTE network may actively hand off the wireless communication device 704 to an eHRPD network. However, before the wireless communication device 704 may be handed off to eHRPD, a DO session negotiation may need to be initiated. Further, signal measurements and pre-registration may be required before the wireless communication device 704 is actively handed off to eHRPD. As described previously, phase 1 may be initiated while the wireless communication device 704 is connected on the LTE network via S101.

The wireless communication device 704 may receive 712 measurement requirements 270 from the eNodeB 702. The measurement requirements 270 may instruct the wireless communication device 704 to measure signal conditions and report results to the eNodeB 702. The wireless communication device 704 may take 714 a measurement of signal levels in CDMA neighboring cells. For example, the wireless communication device 704 may measure eHRPD pilot signals to report back to the eNodeB 702.

The wireless communication device 704 may determine 716 that the wireless communication device 704 is not pre-registered. The wireless communication device 704 may send 718 a measurement report to the eNodeB 702. The measurement report may be accompanied by the pre-registration parameter 246 set to false. The eNodeB 702 may make 720a a handoff decision based on the measurement report and the pre-registration parameter 246 set to false. The eNodeB 702 may deny 722 the active handoff because the wireless communication device 704 is not pre-registered to communicate with eHRPD.

The wireless communication device 704 may subsequently determine 724 that the wireless communication device 704 is pre-registered. For example, the wireless communication device 704 may determine 724 that the wireless communication device 704 is pre-registered after an identifier is assigned, an eHRPD session is created, an eHRPD session and a PPP context are created or an eHRPD session and a PPP, IP and QoS context are created. Determining if the wireless communication device 704 is pre-registered is described above in connection with FIG. 6.

The wireless communication device 704 may send 726 a measurement report to the eNodeB 702. The measurement report may be accompanied by the pre-registration parameter 246 set to true. The eNodeB 702 may make 720b a handoff decision based on the measurement report and the pre-registration parameter 246 set to true. The eNodeB 702 may accept 728 the active handoff because the wireless communication device 704 is pre-registered.

The wireless communication device 704 may complete 730 handoff procedures with the eAN 710 (e.g., phase 2 and/or phase 3). For example, the wireless communication device 704 and the eAN 710 may complete session negotiations (e.g., phase 3). The eAN 710 may acquire 732 the wireless communication device 704 and the active handoff may be complete.

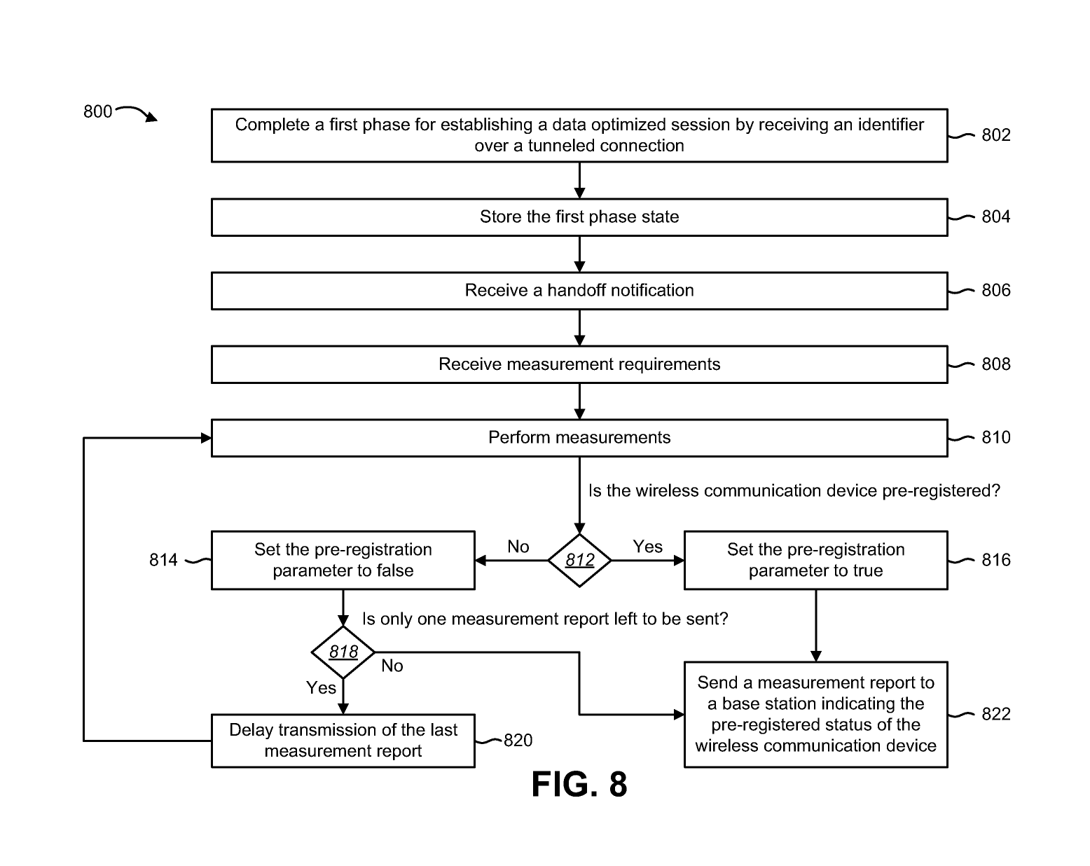

FIG. 8 is a flow diagram of a method 800 for facilitating active handoff using pre-registration status reporting. The method may be performed by a wireless communication device 104. The wireless communication device 104 may complete 802 a first phase for establishing a data optimized session by receiving an identifier 236 over a tunneled connection. For example, a source RAN base station 102a may establish an S101 tunnel connection with the target RAN 110. The wireless communication device 104 may receive an identifier 236, such as a UATI, over the S101 connection.

The wireless communication device 104 may store 804 the first phase state. This may be accomplished as described above in connection with FIG. 2 above.

The wireless communication device 104 may receive 806 a handoff notification. For example, the wireless communication device 104 may be notified that it is being handed off using an S101 connection from the source RAN 108 to the target RAN 110. In some cases, the wireless communication device 104 may determine that a handoff is necessary.

When the wireless communication device 104 is being actively handed off, the target RAN base station 102b may send measurement requirements 270 to the wireless communication device 104. In some configurations, when the base station 102 sends the measurement requirements 270 to the wireless communication device 104, the measurement requirements 270 specify the number of measurement reports to be sent to the base station 102. However, in current configurations, all the measurement reports may be sent to the base station 102 before the wireless communication device 104 becomes pre-registered. Because the pre-registration parameter 246 accompanies each measurement report, if all the measurement reports are sent, the base station 102 may not receive an indication that the wireless communication device 104 is pre-registered. In this case, active handoff to eHRPD cannot proceed because the wireless communication device 104 is not pre-registered to communicate with the eHRPD network. Therefore, it may be beneficial to allow the wireless communication device 104 to delay sending the last measurement report to the base station 102 until the wireless communication device 104 becomes pre-registered.

The wireless communication device 404 may receive 808 measurement requirements 270. The measurement requirements 270 may be received, for example, from a base station 102. The measurement requirements 270 may instruct the wireless communication device 104 to measure signal conditions and report results to the base station 102. The wireless communication device 104 may perform 810 measurements. The measurements may be included in a measurement report. For example, the report module 248 in the measurement module 222 may compile the measurement report. The wireless communication device 104 may also send a pre-registration status along with the measurement report.

The wireless communication device 104 may determine 812 whether the wireless communication device 104 is pre-registered. Determining 812 if the wireless communication device 104 is pre-registered is described above in connection with FIG. 6. Depending on the determination 812, the wireless communication device 104 may set 816 the pre-registration parameter 246 to true or set 814 the pre-registration parameter 246 to false.

If the pre-registration parameter 246 is set 814 to false, the wireless communication device 104 may determine 818 if there is one measurement report left to be sent. If there is only one measurement report remaining, the wireless communication device 104 may delay 820 transmission of the last measurement report. In this manner, the active handoff may be facilitated and unnecessary delays to the active handoff process may be avoided.

If the pre-registration parameter 246 is set 814 to false and it is determined 818 that there is more than one measurement report reaming, the wireless communication device 104 may send 822 a measurement report indicating the pre-registration status of the wireless communication device 104. If the pre-registration parameter 246 is set 716 to true, the wireless communication device 104 may send 822 a measurement report indicating the pre-registration status of the wireless communication device 104. The measurement report with the accompanying pre-registration parameter 246 may be sent to a base station 102. As described above, the base station 102 may make a handoff determination based on the measurement report and the pre-registration parameter 246. Active handoff procedures may proceed based on the handover determination. The active handoff may proceed once the wireless communication device 104 is pre-registered. For example, phase 2 and/or phase 3 may be completed after the active handoff.

FIG. 9 is a block diagram illustrating various types of connectivity between a wireless communication device 904 and a core network 996 on a network 900. The wireless communication device 904 may be one configuration of the wireless communication device 104 described in connection with FIG. 1. For example, the wireless communication device 904 may include an LTE RAT interface 916, an eHRPD RAT interface 918, a session module 920 and a measurement module 922 that correspond to similar element 116, 118, 120 and 122 described in connection with FIG. 1.

The wireless communication device 904 may utilize the network 900 for data services and/or voice services. The network architecture may include data connectivity via an evolved high rate packet data (eHRPD) airlink 974 and an eHRPD RAN 910 to a core network 996. The eHRPD RAN 910 may employ an A10 interface 976 to connect to an HRPD serving gateway (HSGW) 982. The HSGW 982 may connect to a first packet data network gateway (PDN-GW) 986a, a second PDN-GW 986b and a third PDN-GW 986c via S2A interfaces 984a-c, respectfully.

The network architecture may also include data connectivity to the core network 996 via an LTE airlink 978 and an LTE RAN 908 via an LTE eNode B (not shown). The LTE RAN 908 may employ an S1-U interface 980 to connect to a serving gateway (SGW) 992. The SGW 992 may connect with the first PDN-GW 986a, the second PDN-GW 986b and the third PDN-GW 986c via S5 interfaces 994a-c, respectively.

The first PDN-GW 986a may connect to a first access point name (APN) 990a. The second PDN-GW 986b may connect to a second APN 990b. The third PDN-GW 986c may connect to a third APN 990c. An APN 990 may include, but is not limited to, an internet multimedia system (IMS) that a wireless communication device 904 may connect to for obtaining voice over IP (VoIP) or video telephony services or an administrative APN 990. The wireless communication device 904 may establish a connection in order to download configuration information for the wireless communication device 904.

The wireless communication device 904 may move through the network 900. As the wireless communication device 904 moves through the network 900, the wireless communication device 904 may move from an area with coverage provided by one radio access technology (RAT) (e.g., the LTE RAN 908) to an area with coverage provided by another RAT (e.g., the eHRPD RAN 910). Thus, the wireless communication device 904 may switch from a source RAN 108 to a target RAN 110. A common core network 996 may support both RANs with their respective RATs.

FIG. 10 is a block diagram illustrating the network architecture for evolved high rate packet data (eHRPD). The network 1000 may include a wireless communication device 1004. The wireless communication device 1004 may be one configuration of the wireless communication device 104 described in connection with FIG. 1.

The wireless communication device 1004 may obtain services from multiple access points via multiple PDN-GWs 1057. Such a connection from a wireless communication device 904 to PDN-GW 1057 may be called a packet data network (PDN) connection.

A PDN connection between the wireless communication device 1004 and the PDN-GW 1057 is not a direct connection. In eHRPD, the HSGW 1079 communicates with the wireless communication device 1004 and manages every PDN connection with the wireless communication device 1004. In LTE, an SGW 992 communicates with the wireless communication device 1004 and manages PDN connection with the wireless communication device 1004. The HSGW 1079 or SGW 992 then communicates with the PDN-GW 1057 for each PDN connection.

In 3GPP2 1019, the wireless communication device 1004 may communicate with an HRPD base transceiver station (BTS) 1023 via a Um interface 1021a or a 1x radio transmission technology (RTT) BTS 1025 via a Um interface 1021b. The 1xRTT BTS 1025 may communicate with a base station controller (BSC)/packet control function (PCF) 1029 via an Abis interface 1037c. The BSC/PCF 1029 may then communicate with a packet data switched network (PDSN) 1043 via an A10/A11 interface 1041c. The PDSN 1043 may communicate with an AN/PCF 1031 via an A10/A11 interface 1041b. The HRPD BTS 1023 may communicate with the AN/PCF 1031 via an Abis interface 1037b. The AN/PCF 1031 may communicate with an AN-AAA (authentication, authorization and accounting access network) 1047 via an A12 interface 1045b.

The HRPD BTS 1023 may communicate with an eAN/PCF 1035 via an Abis interface 1037a. The eAN/PCF 1035 may then communicate with the AN-AAA 1047 via an A12 interface 1053b. The eAN/PCF 1035 may further communicate with an HSGW 1079 via an A10/A11 interface 1041a. The HSGW 1079 may communicate with a 3GPP2 AAA 1049 via a Pi interface 1077. The A13/A16 interface 1033a-b may be the interface between two ANs/PCFs 1031 or two evolved access networks eANs/PCFs 1035. The H1/H2 interface 1039 may be the interface between two HSGWs 1079.

The evolved universal mobile telecommunications system (UMTS) terrestrial radio access network (E-UTRAN)/evolved packet core (EPC) 1017 may include a home subscriber service (HSS) 1075, one or more PDN-GWs 1057, a policy charging and rules function (PCRF) 1063, operator IP services 1067 (e.g., IMS, packet-switched streaming service (PSS), etc.) and a 3GPP AAA server 1053. The PDN-GW 1057 may communicate with the HSGW 1079 via an S2a interface 1055, with the PCRF 1063 via a Gx interface 1061, with the operator IP services 1067 via an SGi interface 1065 and with the 3GPP AAA server 1053 via an S6b interface 1071. PCRF 1063 may communicate with HSGW 1079 via a Gxa interface 1059 and with the operator IP services 1067 via an Rx interface 1069. The 3GPP AAA server 1053 may communicate with the 3GPP2 AAA server 1049 via an STa interface 1051 and with the HSS 1075 via an SWx interface 1073.

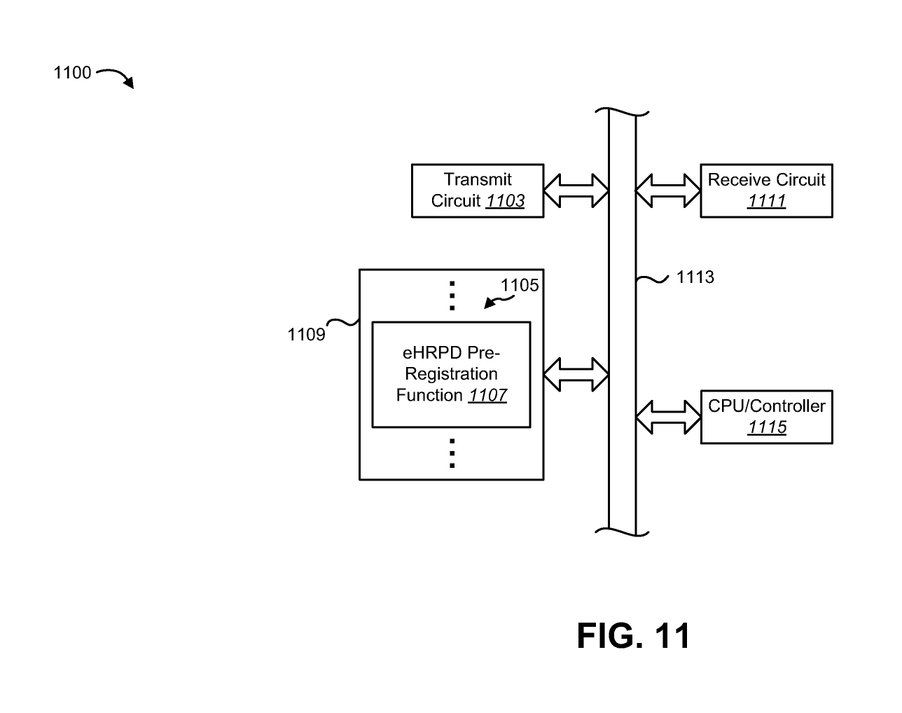

FIG. 11 shows part of a hardware implementation of an apparatus 1100 for executing the pre-registration methods described herein. The apparatus 1100 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 11.

In this embodiment, the circuit apparatus is signified by the reference numeral 1100 and can be implemented in the wireless communication devices 114, 204, 404, 504, 704, 904 and 1004 described herein. The apparatus 1100 comprises a central data bus 1113 linking several circuits together. The circuits include a CPU (Central Processing Unit) or a controller 1115, a receive circuit 1111, a transmit circuit 1103, and a memory unit 1109.

The receive circuit 1111 and the transmit circuit 1103 can be connected to an RF (radio frequency) circuit (not shown). The receive circuit 1111 processes and buffers received signals before sending the signals out to the data bus 1113. On the other hand, the transmit circuit 1103 processes and buffers the data from the data bus 1113 before sending the data out of the device 1100. The CPU/controller 1115 performs the function of data management of the data bus 1113 and furthers the function of general data processing, including executing the instructional contents of the memory unit 1109.

The memory unit 1109 includes a set of modules and/or instructions generally signified by the reference numeral 1105. In this embodiment, the modules/instructions include, among other things, a pre-registration function 1107, such as an eHRPD pre-registration function, which carries out the schemes and processes as described above. The pre-registration function 1107 includes computer instructions or code for executing the process steps as shown and described in FIGS. 1-10. Specific instructions particular to an entity can be selectively implemented in the function 1107. For instance, if the apparatus 1100 is part of a wireless communication device 114, among other things, instructions particular to the wireless communication device 114, as shown and described in FIGS. 1-10, can be coded in the function 1107.

In this embodiment, the memory unit 1109 is a random access memory (RAM) circuit. The exemplary functions, such as the function 1107, include one or more software routines, modules and/or data sets. The memory unit 1109 can be tied to another memory circuit (not shown) which can either be of the volatile or nonvolatile type. As an alternative, the memory unit 1109 can be made of other circuit types, such as an electrically erasable programmable read only memory (EEPROM), an electrical programmable read only memory (EPROM), a read only memory (ROM), an application specific integrated circuit (ASIC), a magnetic disk, an optical disk and others well known in the art.

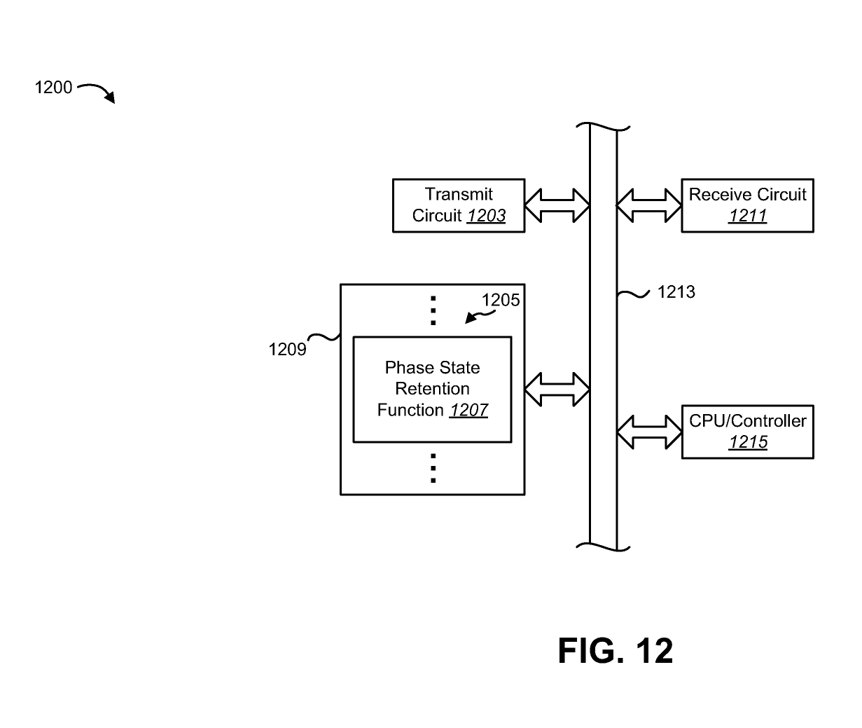

FIG. 12 shows part of a hardware implementation of an apparatus 1200 for executing the schemes or processes as described above. The apparatus 1200 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 12.

In this embodiment, the circuit apparatus is signified by the reference numeral 1200 and can be implemented in the wireless communication devices 104, 204, 404, 504, 704, 904 and 1004 described herein. The apparatus 1200 comprises a central data bus 1213 linking several circuits together. The circuits include a CPU or a controller 1215, a receive circuit 1211, a transmit circuit 1203 and a memory unit 1209.

If the apparatus 1200 is part of a wireless device, the receive circuit 1211 and the transmit circuit 1203 can be connected to an RF circuit (not shown). The receive circuit 1211 processes and buffers received signals before sending the signals out to the data bus 1213. On the other hand, the transmit circuit 1203 processes and buffers the data from the data bus 1213 before sending the data out of the device 1200. The CPU/controller 1215 performs the function of data management of the data bus 1213 and furthers the function of general data processing, including executing the instructional contents of the memory unit 1209.

The memory unit 1209 includes a set of modules and/or instructions generally signified by the reference numeral 1205. In this embodiment, the modules/instructions include, among other things, a phase state retention function 1207, which carries out the schemes and processes as described above. The function 1207 includes computer instructions or code for executing the process steps as shown and described in FIGS. 1-10. Specific instructions particular to an entity can be selectively implemented in the function 1207.

In this embodiment, the memory unit 1209 is a RAM circuit. The exemplary functions, such as the function 1207, include one or more software routines, modules and/or data sets. The memory unit 1209 can be tied to another memory circuit (not shown) which can either be of the volatile or nonvolatile type. As an alternative, the memory unit 1209 can be made of other circuit types, such as an EEPROM, an EPROM, a ROM, an ASIC, a magnetic disk, an optical disk and others well known in the art.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The 3rd Generation Partnership Project (3GPP) is a collaboration between groups of telecommunications associations that aims to define a globally applicable 3rd generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems and mobile devices. In 3GPP LTE, a mobile station or device may be referred to as a wireless communication device.

Wireless communication systems are widely deployed to provide various types of communication content such as voice, data and so on. Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (NT) transmit antennas and multiple (NR) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A wireless communication system may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device to extract transmit beamforming gain from communications received by the transmitting wireless device.

A wireless communication system may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd generation partnership project (3GPP) long term evolution (LTE) systems and spatial division multiple access (SDMA) systems.

The terms “networks” and “systems” are often used interchangeably. A CDMA network may implement a radio technology such as universal terrestrial radio access (UTRA), cdma2000, etc. UTRA includes W-CDMA and low chip rate (LCR) while cdma2000 covers IS-2000, IS-95 and IS-856 standards. A TDMA network may implement a radio technology such as global system for mobile communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and LTE are described in documents from 3GPP. Cdma2000 is described in documents from 3GPP2.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can store desired program code in the form of instructions or data structures and that can be accessed by a computer or processor. Disk and disc, as used herein, include compact disc (CD), laser disc, optical disc, digital versatile disc (DVD), floppy disk and Bluray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatuses described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A communication entity for negotiating a data optimized session, comprising:
means for completing a first phase for establishing the data optimized session, wherein the first phase is complete upon receiving an identifier;
means for storing a first phase state;
means for starting a second phase for establishing the data optimized session, wherein the second phase is interrupted; and
means for restarting the second phase using the stored first phase state, wherein the first phase is not repeated.

2. The communication entity of claim 1, wherein the second phase establishes a connection between the communication entity and a radio access network, and wherein the communication entity is a wireless communication device.

3. The communication entity of claim 2, further comprising means for initiating a third phase for establishing a data optimized session, wherein the communication entity and the radio access network negotiate one of a set of protocols and application subtypes.

4. The communication entity of claim 1, wherein means for storing the identifier comprises means for retaining the state of the first phase, and wherein the identifier is a unicast access terminal identifier.

5. The communication entity of claim 1, wherein the first phase is complete while the communication entity is connected to a long term evolution network via an S101 connection.

6. The communication entity of claim 5, further comprising:
means for determining a pre-registration status of the communication entity; and
means for sending a measurement report to a base station that indicates the pre-registration status of the communication entity if the pre-registration status of the communication entity is set to true.

7. The communication entity of claim 6, wherein the pre-registration status of the communication entity is configured in a parameter.

8. The communication entity of claim 7, wherein the parameter is preRegistrationStatusHRPD.

9. The communication entity of claim 7, wherein the parameter is set by the communication entity to true when a unicast access terminal identifier assignment is complete.

10. The communication entity of claim 7, wherein the parameter is set by the communication entity to true when an evolved high rate packet data session is created.

11. The communication entity of claim 7, wherein the parameter is set by the communication entity to true when an evolved high rate packet data session and a point-to-point protocol context are created.

12. The communication entity of claim 7, wherein the parameter is set by the communication entity to true when an evolved high rate packet data session and one of a point-to-point protocol, internet protocol and quality of service context are created.

13. The communication entity of claim 6, further comprising:
means for determining that the pre-registration status is set to false when only a last measurement report is left;
means for delaying transmission of the last measurement report until the pre-registration status is set to true; and
means for sending a measurement report to the base station that indicates the pre-registration status is set to true.

14. The communication entity of claim 1, wherein the second phase is interrupted by handing over the communication entity from a first radio access technology to a second radio access technology.

15. The communication entity of claim 14, wherein the first radio access technology is a long term evolution network and the second radio access technology is a data optimized network.

16. The communication entity of claim 15, wherein the data optimized network is an evolved high rate packet data network.

17. A communication entity for negotiating a data optimized session, comprising:
circuitry configured to complete a first phase for establishing the data optimized session, wherein the first phase is complete upon receiving an identifier, store a first phase state, start a second phase for establishing the data optimized session, wherein the second phase is interrupted, and restart the second phase using the stored first phase state, wherein the first phase is not repeated.

18. The communication entity of claim 17, wherein the second phase establishes a connection between the communication entity and a radio access network, and wherein the communication entity is a wireless communication device.

19. The communication entity of claim 18, wherein the circuitry is further configured to initiate a third phase for establishing a data optimized session, wherein the communication entity and the radio access network negotiate one of a set of protocols and application subtypes.

20. The communication entity of claim 17, wherein the circuitry configured to store the identifier comprises the circuitry configured to retain the state of the first phase, and wherein the identifier is a unicast access terminal identifier.

21. The communication entity of claim 17, wherein the first phase is complete while the communication entity is connected to a long term evolution network via an S101 connection.

22. The communication entity of claim 21, further comprising:
circuitry configured to determine a pre-registration status of the communication entity, and send a measurement report to a base station that indicates the pre-registration status of the communication entity if the pre-registration status of the communication entity is set to true.

23. The communication entity of claim 22, wherein the pre-registration status of the communication entity is configured in a parameter.

24. The communication entity of claim 23, wherein the parameter is preRegistrationStatusHRPD.

25. The communication entity of claim 23, wherein the parameter is set by the communication entity to true when a unicast access terminal identifier assignment is complete.

26. The communication entity of claim 23, wherein the parameter is set by the communication entity to true when an evolved high rate packet data session is created.

27. The communication entity of claim 23, wherein the parameter is set by the communication entity to true when an evolved high rate packet data session and a point-to-point protocol context are created.

28. The communication entity of claim 23, wherein the parameter is set by the communication entity to true when an evolved high rate packet data session and one of a point-to-point protocol, internet protocol and quality of service context are created.

29. The communication entity of claim 22, wherein the circuitry is further configured to:
determine that the pre-registration status is set to false when only a last measurement report is left;
delay transmission of the last measurement report until the pre-registration status is set to true; and
send a measurement report to the base station that indicates the pre-registration status is set to true.

30. The communication entity of claim 17, wherein the second phase is interrupted by handing over the communication entity from a first radio access technology to a second radio access technology.

31. The communication entity of claim 30, wherein the first radio access technology is a long term evolution network and the second radio access technology is a data optimized network.

32. The communication entity of claim 31, wherein the data optimized network is an evolved high rate packet data network.

33. A method for negotiating a data optimized session, the method being implemented by a communication entity, the method comprising:
completing a first phase for establishing the data optimized session, wherein the first phase is complete upon receiving an identifier;
storing a first phase state;
starting a second phase for establishing the data optimized session, wherein the second phase is interrupted; and
restarting the second phase using the stored first phase state, wherein the first phase is not repeated.

34. The method of claim 33, wherein the second phase establishes a connection between the communication entity and a radio access network, and wherein the communication entity is a wireless communication device.

35. The method of claim 33, wherein storing the identifier comprises retaining the state of the first phase, and wherein the identifier is a unicast access terminal identifier.

36. The method of claim 33, wherein the first phase is complete while the communication entity is connected to a long term evolution network via an S101 connection.

37. The method of claim 36, further comprising:
determining a pre-registration status of the communication entity; and
sending a measurement report to a base station that indicates the pre-registration status of the communication entity if the pre-registration status of the communication entity is set to true.

38. The method of claim 37, wherein the pre-registration status of the communication entity is configured in a parameter.

39. The method of claim 38, wherein the parameter is set by the communication entity to true when an evolved high rate packet data session and one of a point-to-point protocol, internet protocol and quality of service context are created.

40. The method of claim 37, further comprising:
determining that the pre-registration status is set to false when only a last measurement report is left;
delaying transmission of the last measurement report until the pre-registration status is set to true; and
sending a measurement report to the base station that indicates the pre-registration status is set to true.

41. The method of claim 33, wherein the second phase is interrupted by handing over the communication entity from a first radio access technology to a second radio access technology.

42. A computer-program product for negotiating a data optimized session for a communication entity, the computer-program product comprising a computer-readable medium having instructions thereon, the instructions comprising:
code for completing a first phase for establishing the data optimized session, wherein the first phase is complete upon receiving an identifier;
code for storing a first phase state;
code for starting a second phase for establishing the data optimized session, wherein the second phase is interrupted; and
code for restarting the second phase using the stored first phase state, wherein the first phase is not repeated.

43. The computer-program product of claim 42, wherein the second phase establishes a connection between the communication entity and a radio access network, and wherein the communication entity is a wireless communication device.

44. The computer-program product of claim 42, wherein the code for storing the identifier comprises code for retaining the state of the first phase, and wherein the identifier is a unicast access terminal identifier.

45. The communication entity of claim 42, wherein the first phase is complete while the communication entity is connected to a long term evolution network via an S101 connection.

46. The computer-program product of claim 45, the instructions further comprising:
code for determining a pre-registration status of the communication entity; and
code for sending a measurement report to a base station that indicates the pre-registration status of the communication entity if the pre-registration status of the communication entity is set to true.

47. The computer-program product of claim 46, wherein the pre-registration status of the communication entity is configured in a parameter.

48. The computer-program product of claim 47, wherein the parameter is set by the communication entity to true when an evolved high rate packet data session and one of a point-to-point protocol, internet protocol and quality of service context are created.

49. The computer-program product of claim 46, the instructions further comprising:
code for determining that the pre-registration status is set to false when only a last measurement report is left;
code for delaying transmission of the last measurement report until the pre-registration status is set to true; and
code for sending a measurement report to the base station that indicates the pre-registration status is set to true.

50. The computer-program product of claim 42, wherein the second phase is interrupted by handing over the communication entity from a first radio access technology to a second radio access technology.
